(19) United States
(12) Patent Application Publication
(10) Pub. No.: US 2020/0256286 A1
(43) Pub. Date: Aug. 13, 2020

(54) EVAPORATED FUEL TREATMENT APPARATUS

(71) Applicant: AISAN KOGYO KABUSHIKI KAISHA, Obu-shi (JP)

(72) Inventor: Daisaku Asanuma, Gamagori-shi (JP)

(73) Assignee: AISAN KOGYO KABUSHIKI KAISHA, Obu-shi (JP)

(21) Appl. No.: 16/775,756

(22) Filed: Jan. 29, 2020

(30) Foreign Application Priority Data
Feb. 13, 2019 (JP) 2019-023213

(51) Int. Cl. F02M 25/08; F02M 35/10; G01M 3/28

(52) U.S. Cl. CPC F02M 25/0809; F02M 25/0854; G01M 3/2815; F02M 25/0836; F02M 35/10222; F02M 25/0872

(57) ABSTRACT

An evaporated fuel treatment apparatus is provided to determine pipe abnormalities (clogging or leakage) without discharging evaporated fuel to the atmosphere. The evaporated fuel processing apparatus includes an abnormality determination section for determining an abnormality of a vapor passage or a purge passage, drives a purge pump while an engine is operating, opens a purge control valve, sets the purge passage (upstream passage) and the vapor passage on the upstream side of the purge control valve to be under a negative pressure, and determines an abnormality of the vapor passage or the purge passage based on a pressure detected by a pressure sensor.

### CROSS-REFERENCE TO RELATED APPLICATIONS

This application is based upon and claims the benefit of priority from the prior Japanese Patent Application No. 2019-023213, filed Feb. 13, 2019, the entire contents of which are incorporated herein by reference.

### BACKGROUND

### Technical Field

The present disclosure relates to an evaporated fuel treatment apparatus for supplying evaporated fuel (fuel vapor) generated in a fuel tank to an internal combustion engine and treating the evaporated fuel.

### Related Art

In the evaporated fuel treatment apparatus, when an abnormality such as clogging or leakage occurs in a passage, the evaporated fuel is discharged to the atmosphere. In order to detect occurrence of such discharging of the evaporated fuel, it is required to determine any abnormality in the passage.

For example, an evaporated fuel treatment apparatus for performing an abnormality determination in a passage described in Patent Document 1 has been known. The evaporated fuel treatment apparatus includes a canister, a purge control valve for opening and closing a purge passage of the canister, an atmosphere shutoff valve for opening an atmosphere passage, and a pressure sensor for detecting a pressure in a fuel tank. In the evaporated fuel treatment apparatus, the purge control valve and the atmosphere shutoff valve are opened and closed during operation of an engine, and abnormality (clogging or leakage) in the passage is determined based on a changed state of the pressure in the fuel tank at that time.

### RELATED ART DOCUMENTS

### Patent Documents

Patent Document 1: JP H05(1993)-125997A

### SUMMARY

### Technical Problems

However, in the above-mentioned evaporated fuel treatment apparatus, the abnormality (clogging or leakage) in the passage is determined by using the positive pressure of the fuel tank, which could lead to discharging of the evaporated fuel to the atmosphere.

To address the above, the present disclosure has been made to solve the above problem and to provide an evaporated fuel treatment apparatus achieving determination of abnormality (clogging or leakage) of a pipe without discharging the evaporated fuel to the atmosphere.

### Means of Solving the Problems

One aspect of the present disclosure to solve the above problem provides,

an evaporated fuel treatment apparatus comprising: a vapor passage connected to a fuel tank; a canister storing evaporated fuel transferred from the fuel tank through the vapor passage; a purge passage connected to an intake passage that is further connected to an internal combustion engine and the canister; a purge pump provided in the purge passage; a pressure sensor provided downstream of the purge pump; a purge control valve provided downstream of the pressure sensor; an atmosphere passage connected to the canister; and an atmosphere shutoff valve configured to open and close the atmosphere passage, wherein

the evaporated fuel treatment apparatus includes an abnormality determination section for configured to determine abnormality in any one of the vapor passage and the purge passage, and

the abnormality determination section is configured to determine the abnormality in any one of the vapor passage and the purge passage based on a pressure detected by the pressure sensor when the purge pump is driven and the purge control valve is opened to bring the purge passage upstream of the purge control valve and the vapor passage into a negative pressure during operation of the internal combustion engine.

In this evaporated fuel treatment apparatus, the abnormality determination is performed for each passage in a state where the purge passage and the vapor passage are under negative pressure, and thus there is no possibility that the evaporated fuel is discharged to the atmosphere. Accordingly, the abnormality (clogging or leakage) in the vapor passage or the purge passage can be determined without discharging the evaporated fuel to the atmosphere. In addition, in this evaporated fuel treatment apparatus, only by providing the pressure sensor in the purge passage, the abnormality (clogging or leakage) in the passage in the evaporated fuel treatment apparatus can be determined, thus achieving cost reduction.

In the above-mentioned evaporated fuel treatment apparatus, preferably,

the abnormality determination section is configured to determine the abnormality in any one of the vapor passage and the purge passage based on a first pressure difference between a first pressure detected by the pressure sensor when the purge passage upstream of the purge control valve and the vapor passage are made to be under a negative pressure and a second pressure detected by the pressure sensor when a purge flow volume reaches a predetermined amount after the atmosphere shutoff valve is closed.

As described above, by performing the abnormality determination in each passage on the basis of the first pressure difference between the first pressure and the second pressure, that is, a pressure decrease allowance, it is possible to detect presence or absence of clogging in the vapor passage and the leakage in the purge passage. In other words, the rate (speed) of the pressure decrease differs depending on the state of each passage and based on this state of the pressure decrease (the first pressure difference), the presence or absence of the clogging in the vapor passage and the leakage in the purge passage can be detected.

In the above-mentioned evaporated fuel treatment apparatus, preferably,

the abnormality determination section is configured to determine the abnormality in the vapor passage when the first pressure difference is equal to or less than a determination value.

In a case where the first pressure difference is equal to or less than the determination value as described above, it is considered that the pressure drops abruptly, that is, the pressure decreases faster than in the normal state, so that the fuel tank is no longer included in the region where the pressure becomes negative. Namely, the vapor passage is determined to be clogged. The above configuration can thus reliably detect clogging in the vapor passage.

In the above-mentioned evaporated fuel treatment apparatus, preferably,

when the abnormality determination section determines the normality in the passage based on the first pressure difference, the atmosphere shutoff valve is opened and the abnormality determination section is configured to determine the abnormality of the purge passage based on a pressure detected by the pressure sensor after valve-opening.

According to this configuration, the abnormality determination can be performed only to the purge passage. Namely, normality and abnormality in the purge passage can be detected, and when there is the abnormality detected, it is possible to further detect either one of a clogging abnormality or a leakage abnormality.

In the above-mentioned evaporated fuel treatment apparatus, preferably,

the abnormality determination section is configured to determine any one of the normality, the clogging abnormality, or the leakage abnormality in the purge passage depending on which determination range among first to third determination ranges the pressure detected by the pressure sensor belongs to.

According to the state of the purge passage (an upstream side of the purge pump), the pressure detected by the pressure sensor is classified to the following three stages. Specifically, the pressure becomes the highest when there is the leakage in the purge passage, the pressure becomes the lowest when there is the clogging, and the pressure falls in between the highest and the lowest when the pressure is in the normal state. Accordingly, the above configuration can achieve accurate determination of the normality, the clogging abnormality, and the leakage abnormality in the purge passage.

Alternatively, in the above-mentioned evaporated fuel treatment apparatus, preferably, the abnormality determination section is configured to

determine the leakage abnormality in the purge passage based on a second pressure difference between a third pressure detected by the pressure sensor after opening the atmosphere shutoff valve and a fourth pressure detected by the pressure sensor after a first predetermined time has elapsed since closing of the purge control valve, and

determine any one of the normality and the clogging abnormality in the purge passage based on the pressure detected by the pressure sensor after a second predetermined time longer than the first predetermined time has elapsed since closing of the purge control valve.

The behavior of the pressure detected by the pressure sensor differs depending on the state of the purge passage (the upstream side of the pump). When there is the leakage in the purge passage, the pressure in the purge passage turns to an atmospheric pressure (0kPa), and thus the pressure added by the purge pump is directly detected as the pressure in the purge passage. On the other hand, when there is no leakage in the purge passage, a gap is generated between a normal case and a case where the clogging occurs in the increasing speed of the pressure that is detected after the purge control valve is closed. Therefore, this configuration achieves accurate determination of the normality, the clogging abnormality, and the leakage abnormality in the purge passage.

In addition, in the above-mentioned evaporated fuel treatment apparatus, preferably,

the abnormality determination section is configured to correct the determination value based on a remaining rate of fuel in the fuel tank.

According to the above configuration, the abnormality determination of each passage can be performed without being affected by changes in the remaining fuel amount, and thus the erroneous detection of the abnormality can be restrained.

In addition, in the above-mentioned evaporated fuel treatment apparatus, preferably,

the abnormality determination section is configured to determine the abnormality in any one of the vapor passage and the purge passage when a purge concentration is lower than a predetermined value.

The above configuration achieves avoidance of the abnormality determination in a high purge concentration state which has a possibility of erroneous detection. Thereby, erroneous detection of the abnormality can be restrained.

According to the present disclosure, an evaporated fuel treatment apparatus achieving determination of an abnormality (clogging or leakage) in a passage without discharging an evaporated fuel to the atmosphere.

### BRIEF DESCRIPTION OF THE DRAWINGS

FIG. 1 is a schematic diagram showing an overall configuration of an engine system including an evaporated fuel treatment apparatus;

FIG. 2 is a diagram showing a control flow chart of abnormality determination in a first embodiment;

FIG. 3 is a diagram showing an example of a map defining a relationship between a remaining rate of fuel in a fuel tank and a determination value;

FIG. 4 is a diagram showing an example of a control time chart in the first embodiment;

FIG. 5 is a diagram showing a control flow chart of the abnormality determination in a second embodiment;

FIG. 6 is a diagram showing an example of a control time chart in the second embodiment;

FIG. 7 is a diagram showing a control flow chart of the abnormality determination in a third embodiment; and

FIG. 8 is a diagram showing an example of a control time chart in the third embodiment.

### DETAILED DESCRIPTION OF THE EXEMPLARY EMBODIMENTS

An evaporated fuel treatment apparatus according to an embodiment of the present disclosure will be described in detail with reference to the accompanying drawings. The following embodiments are explained with exemplifying a case where the evaporated fuel treatment apparatus of the present disclosure is applied to an engine system mounted on a vehicle such as an automobile.

### First Embodiment

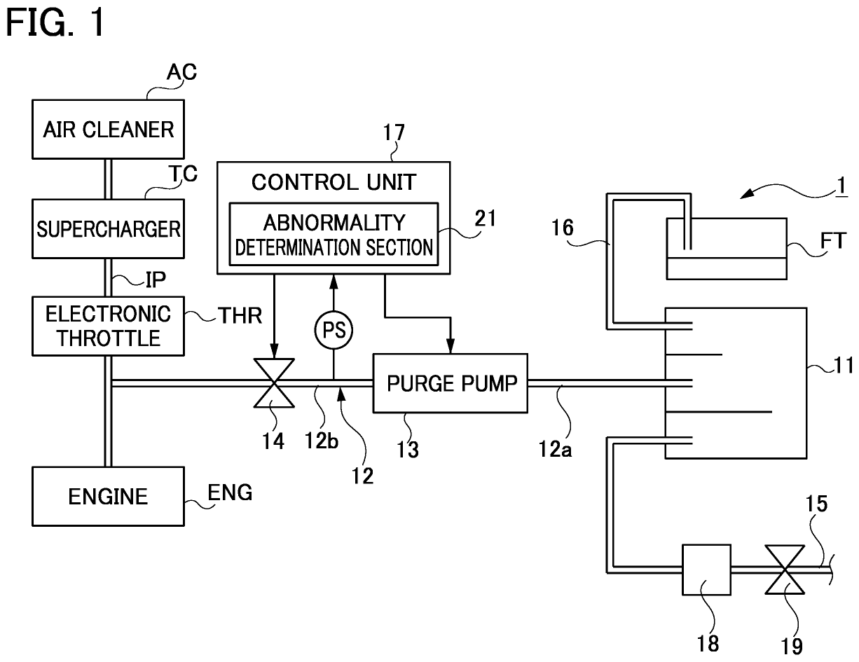

The evaporated fuel treatment apparatus of a first embodiment will be described in detail with reference to FIGS. 1 to 4.

<Overall Configuration of System>

An engine system to which an evaporated fuel treatment apparatus 1 of the present embodiment is applied is mounted on a vehicle such as an automobile and includes an engine ENG as shown in FIG. 1. To this engine ENG, an intake passage IP for supplying air (intake air) to the engine ENG is connected. The intake passage IP is provided with an electronic throttle THR (throttle valve) that opens and closes the intake passage IP to control an amount of air (intake air amount) flowing into the engine ENG, and a supercharger TC that increases density of the air flowing into the engine ENG. An air cleaner AC for removing foreign matters from the air flowing into the intake passage IP is provided upstream (an upstream side in a flow direction of the intake air) of the electronic throttle THR in the intake passage IP. Thus, in the intake passage IP, the air passes through the air cleaner AC and is sucked into the engine ENG.

The evaporated fuel treatment apparatus 1 of the present embodiment is an apparatus for supplying the evaporated fuel in a fuel tank FT to the engine ENG via the intake passage IP in the engine system. The evaporated fuel treatment apparatus 1 includes a canister 11, a purge passage 12, a purge pump 13, a purge control valve 14, an atmosphere passage 15, a vapor passage 16, a control unit 17, a filter 18, an atmosphere shutoff valve 19, a pressure sensor PS, and the like.

The canister 11 is connected to the fuel tank FT via the vapor passage 16 and temporarily stores the evaporated fuel flowing from the fuel tank FT via the vapor passage 16. The canister 11 communicates with the purge passage 12 and the atmosphere passage 15.

The purge passage 12 is connected to the intake passage IP and the canister 11. Accordingly, the purge gas (gas including the evaporated fuel) having flown out of the canister 11 flows through the purge passage 12 and is introduced into the intake passage IP. In the example shown in FIG. 1, the purge passage 12 is connected to a position on a downstream side (a downstream side in the flow direction of the intake air) of the electronic throttle THR in the intake passage IP, but the purge passage 12 is not limited to this location and may be connected to a position on the upstream side of the electronic throttle THR or a position on the upstream side of the supercharger TC in the intake passage IP.

The purge pump 13 is provided in the purge passage 12 and controls the flow of the purge gas flowing through the purge passage 12. Specifically, the purge pump 13 delivers the purge gas in the canister 11 to the purge passage 12 and supplies the purge gas that has been delivered to the purge passage 12 to the intake passage IP.

The purge control valve 14 is provided in the purge passage 12 at a position downstream (a downstream side in the flow direction of the purge gas during execution of purge control) of the purge pump 13, namely provided between the purge pump 13 and the intake passage IP. The purge control valve 14 opens and closes the purge passage 12. When the purge control valve 14 is closed (in a valve-closing state), the purge gas in the purge passage 12 is stopped by the purge control valve 14 and does not flow into the intake passage IP. On the other hand, when the purge control valve 14 is opened (in a valve-opening state), the purge gas flows into the intake passage IP.

One end of the atmosphere passage 15 is opened to the atmosphere and the other end is connected to the canister 11 so that the canister 11 communicates with the atmosphere. Air taken in from the atmosphere flows into the atmosphere passage 15. A filter 18 and the atmosphere shutoff valve 19 are provided in this atmosphere passage 15. The filter 18 removes foreign matters from the air (atmosphere) that flows into the atmosphere passage 15. The atmosphere shutoff valve 19 opens and closes the atmosphere passage 15.

The vapor passage 16 is connected to the fuel tank FT and the canister 11. Thus, the evaporated fuel in the fuel tank FT flows into the canister 11 via the vapor passage 16.

The control unit 17 is a part of an ECU (not shown) mounted on the vehicle and is integrally disposed with other parts of the ECU (for example, a part for controlling the engine ENG). The control unit 17 may be disposed separately from other parts of the ECU. The control unit 17 includes a CPU, an ROM, an RAM, and other memories. The control unit 17 controls the evaporated fuel treatment apparatus 1 and the engine system in accordance with program stored in advance in the memories. For example, the control unit 17 controls the purge pump 13 and the purge control valve 14. Further, the control unit 17 obtains a pressure detection result from the pressure sensor PS.

In the present embodiment, the control unit 17 includes an abnormality determination section 21. The abnormality determination section 21 determines whether there is an abnormality (clogging or leakage) in the vapor passage 16 or the purge passage 12 (specifically, an upstream passage 12a located on the upstream side of the purge pump 13 in the purge passage 12). The “upstream side of the purge pump 13 ” means the upstream side in the flow direction of the purge gas during execution of the purge control, i.e., on the canister 11 side. The abnormality determination section 21 may be provided separately from the control unit 17.

The pressure sensor PS is provided in a downstream passage 12b located on the downstream side of the purge pump 13 in the purge passage 12 (on the downstream side in the flow direction of the purge gas during execution of the purge control, i.e., on the intake passage IP side). The pressure sensor PS thus detects the pressure of the downstream passage 12b in the purge passage 12. A detection signal from the pressure sensor PS is input to the control unit 17.

In the evaporated fuel treatment apparatus 1 having the above configuration, when a purge condition is satisfied during operation of the engine ENG, the control unit 17 controls the purge pump 13 and the purge control valve 14, more specifically, opens the purge control valve 14 while driving the purge pump 13 to execute the purge control. The purge control is control for introducing the purge gas from the canister 11 to the intake passage IP through the purge passage 12.

During execution of the purge control, the engine ENG is supplied with air sucked into the intake passage IP, fuel injected from the fuel tank FT through an injector (not shown), and the purge gas supplied to the intake passage IP by the purge control. The control unit 17 then adjusts injection time of the injector, valve opening time of the purge control valve 14, and others such that an air-fuel ratio (A/F) of the engine ENG is adjusted to an optimum air-fuel ratio (an ideal air-fuel ratio, for example).

<Control Content of Abnormality Determination of Each Passage>

In the present embodiment, determination of presence or absence of abnormality in the vapor passage 16 and the upstream passage 12a in the purge passage 12 is carried out as a self-diagnosis function (On-board diagnostics or OBD) of a vehicle. To be specific, control of the abnormality determination in the passage is carried out in order to detect the presence or absence of the clogging in the vapor passage 16 and the leakage abnormality in the upstream passage 12a.

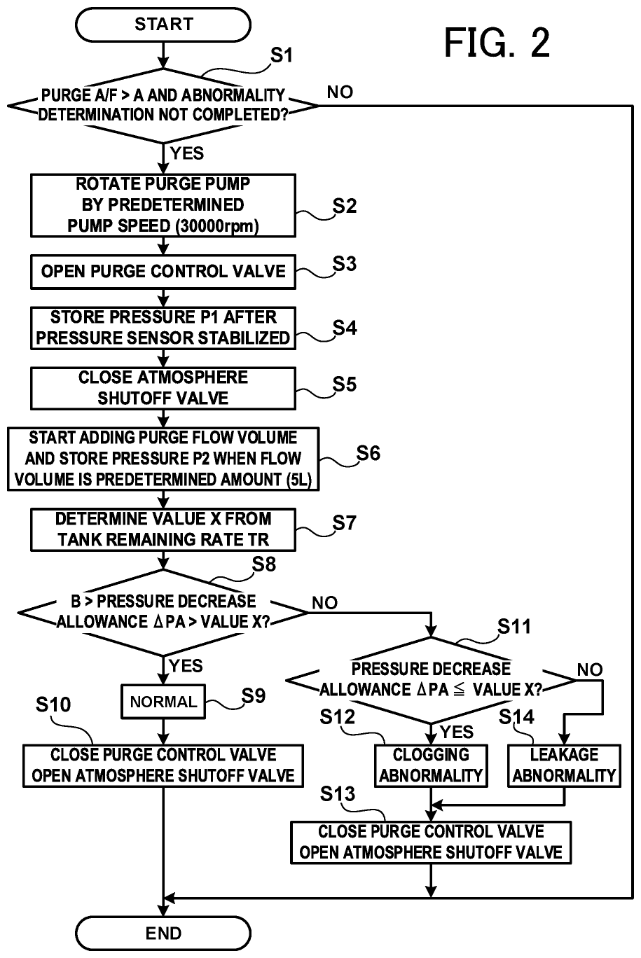

To be more specific, the abnormality determination section 21 of the control unit 17 performs the control based on a control flow chart shown in FIG. 2. The abnormality determination section 21 carries out the abnormality determination control when a purge air-fuel ratio (A/F) is equal to or greater than a predetermined value A (for example, A=5) and when abnormality detection is not completed (step S1:YES). According to this, the abnormality determination control is performed when the purge concentration is lower than a predetermined value (the purge concentration is low), and thus the abnormality determination can be prevented in a state where the purge concentration is high (dense) in which erroneous detection of the abnormality is highly possible. Therefore, in the evaporated fuel treatment apparatus 1 of the present embodiment, erroneous detection of the abnormality in the passage can be restrained.

When the abnormality determination control is performed, the abnormality determination section 21 drives the purge pump 13 at a predetermined pump speed (for instance, 30,000 rpm) (step S2), and opens the purge control valve 14 to be in the valve-opening state (step S3). The purge control valve 14 is under duty-control and may be operated at a constant duty value (for instance, 80 to 100%) in S3.

When an output of the pressure sensor PS is stabilized, the abnormality determination section 21 stores a pressure P1 detected by the pressure sensor PS as a reference pressure (step S4). The abnormality determination section 21 determines that the output of the pressure sensor PS is stabilized when variation in the output of the pressure sensor PS falls within a predetermined range for a predetermined period of time.

Next, the abnormality determination section 21 closes the atmosphere shutoff valve 19 (step S5). In this manner, the abnormality determination section 21 brings the vapor passage 16 and the purge passage 12 into the negative pressure state. Then, the abnormality determination section 21 starts addition of a purge flow volume and stores a pressure P2 detected by the pressure sensor PS when the integrated flow volume reaches a predetermined value (for instance, 5L) (step S6).

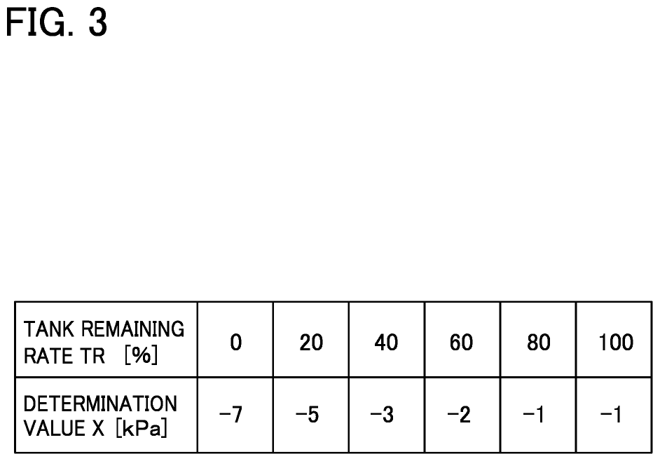

Next, the abnormality determination section 21 determines a determination value X based on a tank remaining rate TR of the fuel in the fuel tank FT by using a map shown in FIG. 3, for example (step S7). As shown in FIG. 3, the determination value X is defined in correspondence with the tank remaining rate TR and is defined so as to increase as the tank remaining rate TR increases. By determining the determination value X in this manner, the abnormality determination of each passage can be performed highly accurately without being affected by the change in the remaining rate of the fuel in the fuel tank FT, and thus the erroneous detection of the abnormality can be restrained. The determination value X may be determined to be an optimum value by experiment in advance according to the configuration of the engine system (the evaporated fuel treatment apparatus 1).

Then, when a pressure decrease allowance ΔPA (=P2−P1) is larger than the determination value X and smaller than a predetermined value B (for example, B=−0.5 kPa) (step S8:YES), the abnormality determination section 21 determines that there is neither clogging nor leakage in the vapor passage 16. In other words, the vapor passage 16 is determined to be normal (step S9). In a case where neither clogging nor leakage occurs in the vapor passage 16, the fuel tank FT is included in a region where the pressure turns negative, and accordingly, it is considered that decrease in the pressure P becomes gradual in the downstream passage 12b , so that the pressure decrease allowance ΔPA falls within a predetermined range. Therefore, the abnormality determination section 21 can determine that the vapor passage 16 is not clogged (normal).

In this manner, the abnormality determination section 21 determines that neither clogging nor leakage has occurred in the vapor passage 16 (normal) when the pressure P in the downstream passage 12b falls gradually within a predetermined range based on the pressure decrease allowance ΔPA. Thereafter, the abnormality determination section 21 closes the purge control valve 14 and opens the atmosphere shutoff valve 19 (step S10).

On the other hand, when the pressure decrease allowance ΔPA is out of the predetermined range, that is, smaller than the determination value X or larger than the predetermined value B (S8:NO), the abnormality determination section 21 determines whether the pressure decrease allowance ΔPA is equal to or smaller than the determination value X (step S11). At this time, when the pressure decrease allowance ΔPA is equal to or less than the determination value X (S11:YES), the abnormality determination section 21 determines that the vapor passage 16 is clogged (clogging abnormality) (step S12). Namely, when the vapor passage 16 is clogged, the fuel tank FT is not included in the region where the pressure turns negative, and thus the pressure P in the downstream passage 12b rapidly decreases. Consequently, the pressure decrease allowance ΔPA is considered to become equal to or less than the determination value X. The abnormality determination section 21 accordingly determines that the clogging (clogging abnormality) has occurred in the vapor passage 16.

As mentioned above, the abnormality determination section 21 determines that clogging has occurred in the vapor passage 16 (clogging abnormality) when the pressure P rapidly decreases to the determination value X or less based on the pressure decrease allowance ΔPA. Thereafter, the abnormality determination section 21 closes the purge control valve 14 and opens the atmosphere shutoff valve 19 (step S13).

When the pressure decrease allowance ΔPA is larger than the determination value X (S11:NO), on the other hand, the abnormality determination section 21 determines that there is a leakage (coming-loose of a hose or the like) in the upstream passage 12a (leakage abnormality) (step S14). To be specific, when there is a leakage in the upstream passage 12a , the pressure P in the upstream passage 12a hardly changes (becomes atmospheric pressure), and that is why it is considered that the pressure decrease allowance APA becomes larger than the determination value X. Therefore, the abnormality determination section 21 can determine there is the leakage (the leakage abnormality) in the upstream passage 12a.

In this manner, the abnormality determination section 21 determines that the leakage has occurred in the upstream passage 12a (leakage abnormality) when the pressure P hardly decreases based on the pressure decrease allowance ΔPA and is larger than the determination value X. Thereafter, the abnormality determination section 21 closes the purge control valve 14 and opens the atmosphere shutoff valve 19 (step S13).

As described above, in the evaporated fuel treatment apparatus 1 of the present embodiment, the abnormality determination of each passage is performed in a state where the vapor passage 16 and the purge passage 12 is under negative pressure, and thus there is no possibility of the evaporated fuel being discharged to the atmosphere. Therefore, the abnormality (clogging or leakage) of the vapor passage 16 or the purge passage 12 can be determined without discharging the evaporated fuel to the atmosphere. Further, in the evaporated fuel treatment apparatus 1, only by providing the pressure sensor PS in the purge passage 12, the abnormality (clogging or leakage) of the vapor passage 16 or the purge passage 12 can be determined, thus reducing the number of the pressure sensors and reducing the cost.

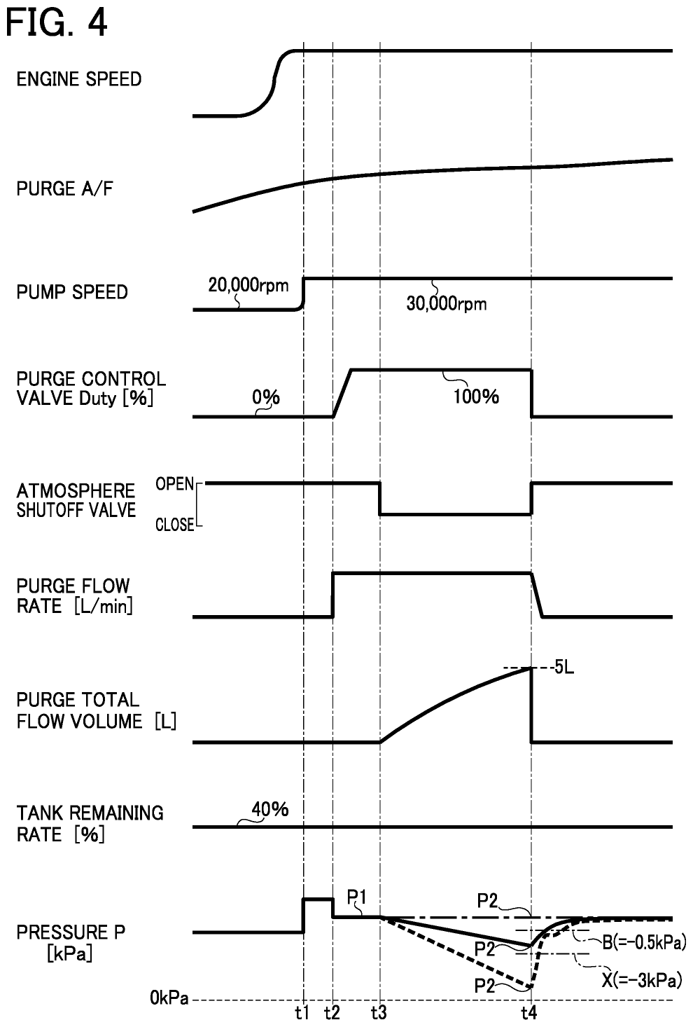

By performing the control based on the control flow chart shown in FIG. 2, an example of the control time chart shown in FIG. 4 is implemented. As shown in FIG. 4, at time t1, the purge pump 13 is driven at 30,000 rpm, the purge control valve 14 is opened at time t2, and the atmosphere shutoff valve 19 is closed at time t3. The pressure P1 is stored between times t2 and t3. Thereafter, integration of the purge flow volume is started from time t3, and the integrated amount reaches 5L at time t4. At this time, the pressure P2 is detected and the pressure decrease allowance ΔPA (=P2−P1) is calculated.

When the pressure decrease allowance ΔPA falls within the range of the determination value X (−3 kPa since the tank remaining rate TR is 40%) and the predetermined value B (B=−0.5 kPa), it is determined that neither clogging nor leakage occurs in the vapor passage 16 and the vapor passage 16 is normal (see a solid line in FIG. 4). On the other hand, when the pressure decrease allowance ΔPA is outside the above range, in a case where the pressure decrease allowance ΔPA is equal to or less than the determination value X (X=−3 kPa), the vapor passage 16 is determined to be clogged (see a broken line in FIG. 4). Further, in another case where the pressure decrease allowance ΔPA is larger than the determination value X (X=−3 kPa), the upstream passage 12a is determined to have the leakage as the leakage abnormality (see a chain-dot line in FIG. 4).

### Second Embodiment

Next, the second embodiment will be described. The present embodiment has the same apparatus configuration as the first embodiment, but differs from the first embodiment in the content of the abnormality determination control performed by the abnormality determination section 21. Namely, in the present embodiment, abnormality determination control for detecting a clogging abnormality and a leakage abnormality in the upstream passage 12a is additionally performed.

<Control Content of Abnormality Determination of Upstream Passage>

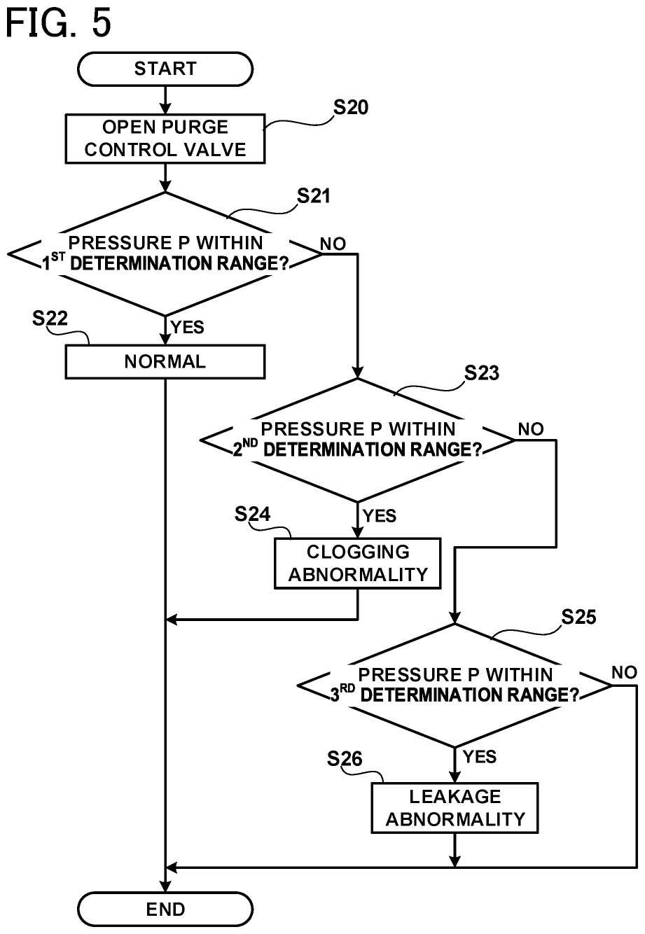

Specifically, the abnormality determination section 21 of the control unit 17 performs control based on the control flow chart shown in FIG. 5. This control is executed after performing the process of S10 of FIG. 2. To be more specific, the abnormality determination section 21 performs the abnormality determination control based on the control flow chart shown in FIG. 5 in a case where the normality determination has been made by the abnormality determination section 21 in the control of the first embodiment. The present embodiment thus achieves both detection of the presence or absence of clogging in the vapor passage 16 and detection of the presence or absence of clogging and leakage in the purge passage 12 (the upstream passage 12a ).

First, as shown in FIG. 5, the abnormality determination section 21 makes the normality determination in the control flow chart of FIG. 2 and performs the process of S10 in FIG. 2, and after that, the purge control valve 14 is opened (step S20). Then, the abnormality determination section 21 determines whether the pressure P detected by the pressure sensor PS is normal, in the clogging abnormality, or in the leakage abnormality in the purge passage 12 (the upstream passage 12a ) depending on which determination range among first to third determination ranges the pressure P belongs to.

This determination can be made because the pressure P differs depending on the state of the purge passage 12 (the upstream passage 12a ). Specifically, in the normal case, a negative pressure is generated in the upstream passage 12a due to presence of the canister 11 and the filter 18 when the purge control valve 14 is opened. Inside of the downstream passage 12b is pressurized since the purge pump 13 is driven at a predetermined pump speed, for example, 30,000 rpm. The pressure P is accordingly detected as the pressure obtained by adding the pressurized pressure of the purge pump 13 to the negative pressure of the upstream passage 12a . When the upstream passage 12a is clogged, on the other hand, the upstream passage 12a is closed, and thus the inside of the downstream passage 12b is hardly pressurized. As a result of this, the pressure P is detected as approximately 0 kPa. Further, when there is a leakage in the upstream passage 12a , the inside of the upstream passage 12a becomes 0 kPa, and accordingly the pressurized pressure of the purge pump 13 is directly detected as the pressure P. As mentioned above, the pressure P of the downstream passage 12b is divided into three stages depending on the state of the purge passage 12 (the upstream passage 12a ). The pressure P is the highest when there is the leakage in the purge passage 12 (the upstream passage 12a ), the pressure P is the lowest when there is the clogging, and the pressure P is the pressure therebetween when the passage is normal. Consequently, the normality, the clogging abnormality, and the leakage abnormality in the purge passage 12 (the upstream passage 12a ) can be accurately determined depending on which determination range among the first to third determination ranges the pressure belongs to.

Therefore, when the pressure P is within the first determination range (step S21:YES), the abnormality determination section 21 determines that the purge passage 12 (the upstream passage 12a ) is normal without clogging or leakage (step S22). In the present embodiment, the first determination range is set to, for example, 2 to 6kPa.

When the pressure P is within the second determination range (S21:NO, step S23:YES), the abnormality determination section 21 determines that the purge passage 12 (the upstream passage 12a ) is clogged (clogging abnormality) (step S24). In the present embodiment, the second determination range is set to, for example, −2 to 2 kPa.

Further, when the pressure P is within the third determination range (S23:NO, step S25:YES), the abnormality determination section 21 determines that there is the leakage (leakage abnormality) in the purge passage 12 (the upstream passage 12a ) (step S26). In the present embodiment, the third determination range is set to, for example, 6 to 10 kPa.

It should be noted that the pressure value for determining the first to third determination ranges may be determined to be an optimum value by experiment in advance in accordance with the configuration of the engine system (the evaporated fuel treatment apparatus 1).

As described above, also in the second embodiment, the abnormality determination of the vapor passage 16 and the purge passage 12 (the upstream passage 12a ) is performed without pressurizing the vapor passage 16 and the purge passage 12 (the upstream passage 12a ), and thus there is no possibility that the evaporated fuel is discharged to the atmosphere. Accordingly, the abnormality (clogging or leakage) in the vapor passage 16 and the purge passage 12 (the upstream passage 12a ) can be determined without discharging the evaporated fuel to the atmosphere. In the second embodiment, it is possible to detect the clogging abnormality in the purge passage 12 (the upstream passage 12a ) which cannot be detected in the first embodiment.

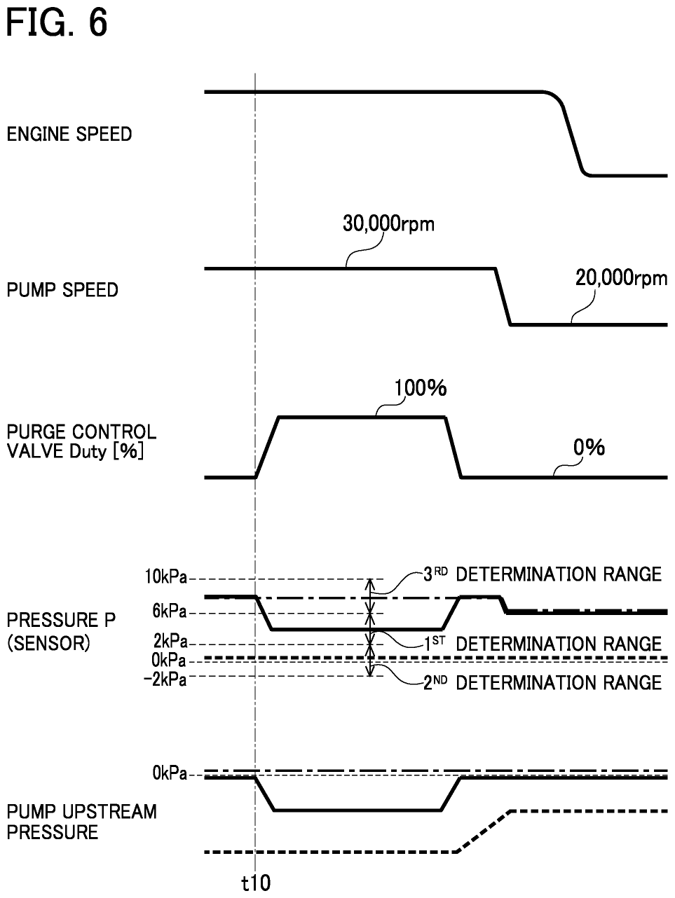

An example of the control time chart shown in FIG. 6 is implemented by performing the control based on the control flow chart shown in FIG. 5. As shown in FIG. 6, at time t10, the purge control valve 14 is opened. When the pressure P detected by the pressure sensor PS falls within the first determination range (2 to 6 kPa), the passage is determined to be normal (see a solid line in FIG. 6). When the pressure P is within the second determination range (−2 to 2 kPa), the purge passage 12 is determined to have the clogging abnormality (see a broken line in FIG. 6), and when the pressure P is within the third determination range (6 to 10 kPa), the passage is determined to have the leakage abnormality (see a chain dot line in FIG. 6).

### Third Embodiment

Finally, the third embodiment will be described. The present embodiment has the same apparatus configuration as the first embodiment, but differs from the first embodiment in the content of the abnormality determination control performed by the abnormality determination section 21. Specifically, in the present embodiment, similarly to the second embodiment, the abnormality determination control for detecting the clogging abnormality and the leakage abnormality in the upstream passage 12a is additionally performed while the control content of the abnormality determination additionally performed is different from the one in the second embodiment.

<Control Content of Abnormality Determination of Upstream Passage>

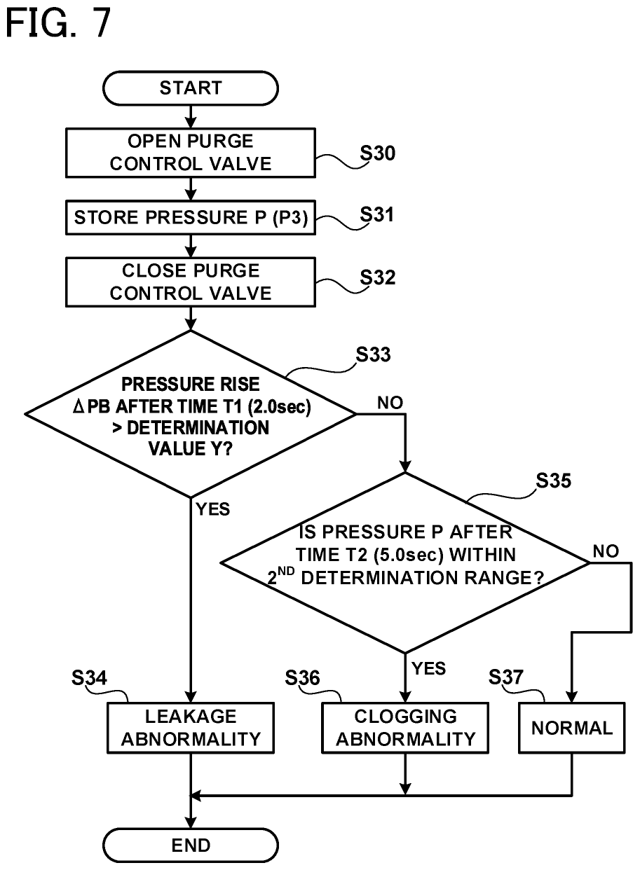

Specifically, the abnormality determination section 21 of the control unit 17 performs the control based on the control flow chart shown in FIG. 7. This control is executed after the process of S10 of FIG. 2 is performed. To be more specific, the abnormality determination section 21 performs the abnormality determination control based on the control flow chart shown in FIG. 7 when the normality determination is made by the control of the first embodiment described above. As a result, in the present embodiment, it is possible to detect the presence or absence of clogging in the vapor passage 16 and the presence or absence of clogging and leakage in the purge passage 12 (the upstream passage 12a ).

First, as shown in FIG. 7, the abnormality determination section 21 makes the normality determination in the control flow chart of FIG. 2 and performs the process of S10 in FIG. 2, and subsequently the purge control valve 14 is opened (step S30). Thereafter, the abnormality determination section 21 stores the pressure P detected by the pressure sensor PS as a pressure P3 (step S31). Subsequently, the purge control valve 14 is closed (step S32), and the abnormality determination section 21 determines whether the purge passage 12 (the upstream passage 12a ) is normal, clogged, or leaked based on a pressure rise ΔPB or the pressure P after a predetermined time has elapsed.

This determination can be made because the behavior of the pressure P differs depending on the state of the purge passage 12 (the upstream passage 12a ). When there is the leakage in the upstream passage 12a , the inside of the upstream passage 12a becomes OkPa (atmospheric pressure), and accordingly, the pressurized pressure of the purge pump 13 is directly detected as the pressure P. On the other hand, when the upstream passage 12a has no leakage, the behavior of the pressure P is different since the rising speed of the pressure P after closing the purge control valve 14 differs between the normal case and the case where there is the clogging.

As a result of the above, when the pressure rise ΔPB (=P4−P3) after a predetermined time T1 (for example, 2 sec) has elapsed since closing of the purge control valve 14 is larger than a determination value Y (for example, Y=2 kPa) (step S33:YES), the abnormality determination section 21 determines that there is the leakage in the purge passage 12 (the upstream passage 12a ) (step S34). The pressure P4 is a pressure detected by the pressure sensor PS after the predetermined time T1 has elapsed since closing of the purge control valve 14. The determination value Y may be an optimum value obtained in advance from an experiment in accordance with the configuration of the engine system (the evaporated fuel treatment apparatus 1).

When the pressure rise ΔPB (=P4−P3) is smaller than the determination value Y (for example, Y=2 kPa) (S33:NO), the abnormality determination section 21 proceeds to the process of step S35. In S35, the abnormality determination section 21 determines whether the pressure P detected by the pressure sensor PS after a predetermined time T2 (for example, 5 sec) longer than the predetermined time T1 has elapsed since closing of the purge control valve 14 falls within the second determination range (for example, −2 to 2 kPa).

At this time, when the pressure P detected by the pressure sensor PS is within the second determination range (S35:YES), the abnormality determination section 21 determines that the purge passage 12 (the upstream passage 12a ) is clogged (clogging abnormality) (step S36). On the other hand, when the pressure P detected by the pressure sensor PS is out of the second determination range (S35:NO), the abnormality determination section 21 determines that the purge passage 12 (the upstream passage 12a ) is normal without leakage or clogging (step S37).

As described above, also in the third embodiment, the abnormality determination of the vapor passage 16 and the purge passage 12 (the upstream passage 12a ) is performed without pressurizing the vapor passage 16 and the purge passage 12 (the upstream passage 12a ), and thus there is no possibility that the evaporated fuel is discharged to the atmosphere. Accordingly, the abnormality (clogging or leakage) in the vapor passage 16 and the purge passage 12 (the upstream passage 12a ) can be determined without discharging the evaporated fuel to the atmosphere. In the third embodiment, it is possible to detect the clogging abnormality of the purge passage 12 (the upstream passage 12a ) which cannot be detected in the first embodiment.

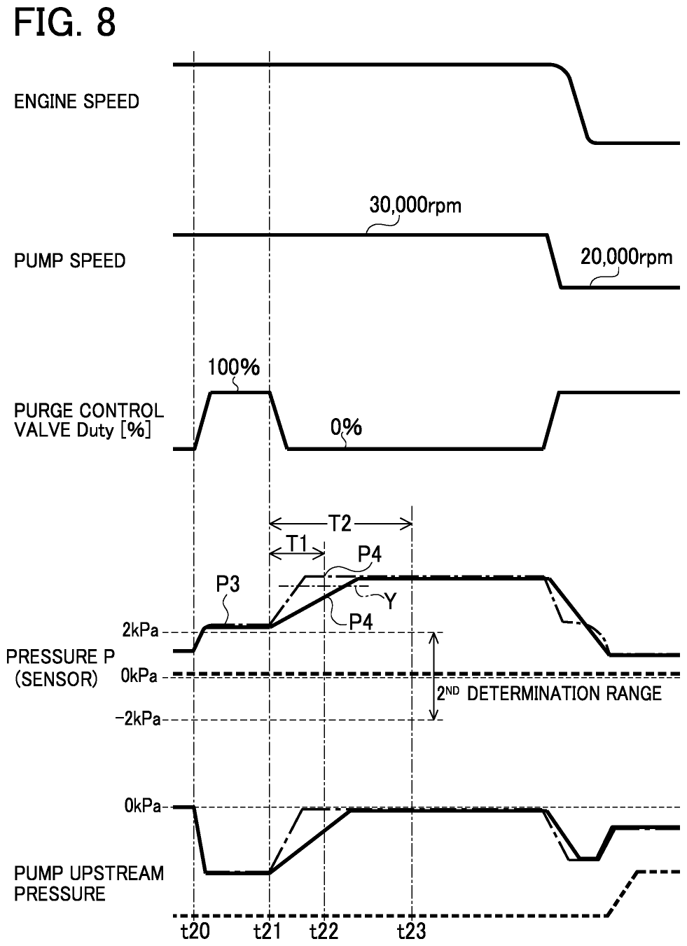

An example of a control time chart as shown in FIG. 8 is implemented by performing the control based on the control flow chart shown in FIG. 7. As shown in FIG. 8, at time t20, the purge control valve 14 is opened. When an output value of the pressure sensor PS is stabilized, the pressure P detected at that time is stored as the pressure P3. Subsequently, at time t21, the purge control valve 14 is closed. The pressure P4 is thereafter detected and the pressure rise ΔPB is calculated at a time t22 at which a predetermined time T1 (=2 sec) has elapsed from the time t21. When the pressure rise ΔPB is larger than the determination value Y (=2 kPa), the passage is determined to be in the leakage abnormality (see a chain dot line in FIG. 8). On the other hand, when the pressure rise ΔPB is smaller than the determination value Y (=2 kPa), at time t23 when the predetermined time T2 (=5 sec) has elapsed from time t21, the clogging abnormality is determined if the pressure P is within the second determination range (−2 to 2 kPa) (see a broken line in FIG. 8), and the normality is determined if the pressure P is outside the second determination range (see a solid line in FIG. 8).

It should be noted that the above-mentioned embodiments are merely examples, and the present disclosure is not limited to the above, and various modifications and variations are possible without departing from the scope thereof. For example, in the above embodiments, the evaporated fuel treatment apparatus of the present disclosure is applied to an engine system with a supercharger TC, but alternatively, the evaporated fuel treatment apparatus of the present disclosure can be applied to a natural intake engine system.

### REFERENCE SIGNS LIST

1 Evaporated fuel treatment apparatus

11 Canister

12 Purge passage

12a Upstream Passage

12b Downstream Passage

13 Purge pump

14 Purge control valve

15 Atmosphere passage

16 Vapor passage

17 Control unit

18 Filter

19 Atmosphere shutoff valve

21 Abnormality determination section

ENG Engine

FT Fuel tank

PS Pressure sensor

What is claimed is:

1. An evaporated fuel treatment apparatus comprising: a vapor passage connected to a fuel tank; a canister storing evaporated fuel transferred from the fuel tank through the vapor passage; a purge passage connected to an intake passage that is further connected to an internal combustion engine and the canister; a purge pump provided in the purge passage; a pressure sensor provided downstream of the purge pump; a purge control valve provided downstream of the pressure sensor; an atmosphere passage connected to the canister; and an atmosphere shutoff valve configured to open and close the atmosphere passage, wherein
the evaporated fuel treatment apparatus includes an abnormality determination section configured to determine abnormality in any one of the vapor passage and the purge passage, and
the abnormality determination section is configured to determine the abnormality in any one of the vapor passage and the purge passage based on a pressure detected by the pressure sensor when the purge pump is driven and the purge control valve is opened to bring the purge passage upstream of the purge control valve and the vapor passage into a negative pressure during operation of the internal combustion engine.

2. The evaporated fuel treatment apparatus according to claim 1, wherein the abnormality determination section is configured to determine the abnormality in any one of the vapor passage and the purge passage based on a first pressure difference between a first pressure detected by the pressure sensor when the purge passage upstream of the purge control valve and the vapor passage are made to be under a negative pressure and a second pressure detected by the pressure sensor when a purge flow volume reaches a predetermined amount after the atmosphere shutoff valve is closed.

3. The evaporated fuel treatment apparatus according to claim 2, wherein the abnormality determination section is configured to determine the abnormality in the vapor passage when the first pressure difference is equal to or less than a determination value.

4. The evaporated fuel treatment apparatus according to claim 2, wherein when the abnormality determination section determines the normality in the purge passage based on the abnormality determination based on the first pressure difference, the atmosphere shutoff valve is opened and the abnormality determination section is configured to determine the abnormality of the purge passage based on a pressure detected by the pressure sensor after valve-opening.

5. The evaporated fuel treatment apparatus according to claim 4, wherein the abnormality determination section is configured to determine any one of the normality, the clogging abnormality, and the leakage abnormality in the purge passage depending on which determination range among first to third determination ranges the pressure detected by the pressure sensor belongs to.

6. The evaporated fuel vapor treatment apparatus according to claim 4, wherein
the abnormality determination section is configured to
determine the leakage abnormality in the purge passage based on a second pressure difference between a third pressure detected by the pressure sensor after opening the atmosphere shutoff valve and a fourth pressure detected by the pressure sensor after a first predetermined time has elapsed since closing of the purge control valve, and
determine any one of the normality and the clogging abnormality in the purge passage based on the pressure detected by the pressure sensor after a second predetermined time longer than the first predetermined time has elapsed since closing of the purge control valve.

7. The evaporated fuel treatment apparatus according to claim 3, wherein the abnormality determination section is configured to correct the determination value based on a remaining rate of fuel in the fuel tank.

8. The evaporated fuel treatment apparatus according to claim 1, wherein the abnormality determination section is configured to determine abnormality in any one of the vapor passage and the purge passage when a purge concentration is lower than a predetermined value.

9. The evaporated fuel treatment apparatus according to claim 2, wherein the abnormality determination section is configured to determine the abnormality in any one of the vapor passage and the purge passage when a purge concentration is lower than a predetermined value.

10. The evaporated fuel treatment apparatus according to claim 3, wherein the abnormality determination section is configured to determine abnormality in any one of the vapor passage and the purge passage when a purge concentration is lower than a predetermined value.

11. The evaporated fuel treatment apparatus according to claim 4, wherein the abnormality determination section is configured to determine abnormality in any one of the vapor passage and the purge passage when a purge concentration is lower than a predetermined value.

12. The evaporated fuel treatment apparatus according to claim 5, wherein the abnormality determination section is configured to determine abnormality in any one of the vapor passage and the purge passage when a purge concentration is lower than a predetermined value.

13. The evaporated fuel treatment apparatus according to claim 6, wherein the abnormality determination section is configured to determine abnormality in any one of the vapor passage and the purge passage when a purge concentration is lower than a predetermined value.

14. The evaporated fuel treatment apparatus according to claim 7, wherein the abnormality determination section is configured to determine abnormality in any one of the vapor passage and the purge passage when a purge concentration is lower than a predetermined value.
